(19) United States
(12) Patent Application Publication
(10) Pub. No.: US 2022/0327868 A1
(43) Pub. Date: Oct. 13, 2022

(54) SERVER AND VEHICLE

(71) Applicants: Hyundai Motor Company, Seoul (KR); Kia Corporation, Seoul (KR)

(72) Inventor: HwaYong Jang, Seongnam (KR)

(21) Appl. No.: 17/499,080

(22) Filed: Oct. 12, 2021

(30) Foreign Application Priority Data
Apr. 12, 2021 (KR) 10-2021-0046973

(51) Int. Cl. G07C 5/00; G07C 5/08; G08G 1/0967

(52) U.S. Cl. CPC G07C 5/008; G07C 5/085; G07C 5/006; G08G 1/096775; B60K 35/00

(57) ABSTRACT

A server including a server memory and a server processor is provided to execute a series of instructions. The instructions include storing position information of a vehicle, driving information, and fuel efficiency information transmitted at predetermined periods from the vehicle in the server memory. The instructions also include receiving weather information according to a vehicle position from a weather and transmitting an appropriate tire air pressure based on the weather information according to the vehicle position to the vehicle, transmitting an appropriate tire air pressure and a tire replacement time based on the weather information according to the vehicle position and the driving information to the vehicle, or transmitting an appropriate tire air pressure and a tire replacement time based on the fuel efficiency information to the vehicle.

### CROSS-REFERENCE TO RELATED APPLICATION

This application claims priority to and the benefit of Korean Patent Application No. 10-2021-0046973 filed on Apr. 12, 2021, the entire contents of which are incorporated herein by reference.

### BACKGROUND

### (a) Field of the Disclosure

The present disclosure relates to a server and a vehicle, and more particularly, to a server and a vehicle that notify a driver of an appropriate tire pressure and a tire replacement time based on weather information, driving information of a vehicle, and fuel efficiency information of the vehicle.

### (b) Description of the Related Art

A tire mounted on a vehicle supports a load of the vehicle from a road surface, transmits driving force, braking force, and the like of the vehicle to the road surface, and performs a function as a spring or a damper that reduces an impact from the road surface. When an air pressure of the tire is greater than a proper air pressure thereof, a tramping phenomenon occurs, which degrades riding comfort and accelerates wear of the tire. On the other hand, when the air pressure of the tire is less than the proper air pressure thereof, the wear of the tire is accelerated, and in severe cases, a puncture occurs in the tire while driving, which may cause an accident, and operability and fuel efficiency of the vehicle are degraded.

Therefore, it is important that the air pressure of the tire is maintained at an appropriate level. Although the vehicle is equipped with a tire pressure monitoring system (TPMS) that measures the tire's air pressure to provide a notification thereof to the driver, the TPMS only detects a current tire's air pressure, but it does not notify a driver of a proper air pressure or replacement timing of the tire that takes into account external conditions of the vehicle.

The above information disclosed in this section is merely for enhancement of understanding of the background of the disclosure, and therefore it may contain information that does not form the prior art that is already known in this country to a person of ordinary skill in the art.

### SUMMARY

The present disclosure has been made in an effort to provide a server and a vehicle that may notify a driver of an appropriate tire air pressure and an appropriate tire replacement time based on a vehicle's driving information and a vehicle's fuel efficiency information.

An embodiment of the present disclosure provides a server including: a server memory; and a server processor executing instructions loaded into the server memory, wherein the server processor executes a series of instructions, that may include: storing a vehicle's position information, a vehicle's driving information, and a vehicle's fuel efficiency information transmitted at predetermined periods from a vehicle in the server memory; receiving weather information according to a position of the vehicle from a weather server to store the information in the server memory; and transmitting an appropriate tire air pressure based on the weather information according to a position of the vehicle to the vehicle, transmitting an appropriate tire air pressure and a tire replacement time based on the weather information according to the position of the vehicle and the vehicle's driving information to the vehicle, or transmitting an appropriate tire air pressure and a tire replacement time based on the vehicle's fuel efficiency information to the vehicle.

The vehicle's driving information may include a vehicle's driving route, driving road information, and a vehicle's driving distance information; and the server processor may be configured to transmit an appropriate tire air pressure and a tire replacement time to the vehicle based on the driving road information and the driving distance information transmitted from the vehicle and external temperature information of the vehicle transmitted from the weather server. The server processor may be configured to transmit tire replacement information to the vehicle when the vehicle travels more or further than a set driving distance on a set driving road. The server processor may be configured to transmit an appropriate tire air pressure to the vehicle based on a previously stored official fuel efficiency of the vehicle and the fuel efficiency information.

The fuel efficiency information may include fuel economy degradation factors including fuel efficiency degradation due to the vehicle's fuel efficiency and an amount of air flowing into the engine, fuel efficiency degradation due to quality of fuel, and fuel efficiency degradation due to a tire air pressure. The server processor may be configured to continuously monitor the fuel efficiency information transmitted from the vehicle, and transmit an appropriate tire air pressure to the vehicle when the vehicle's fuel efficiency is less than an official fuel efficiency due to the fuel efficiency degradation due to the tire air pressure.

Another embodiment of the present disclosure provides a vehicle including: a vehicle memory; and a vehicle controller executing instructions loaded into the vehicle memory, wherein the vehicle controller executes a series of instructions, that may include: transmitting a vehicle's position information, a vehicle's driving information, and a vehicle's fuel efficiency information to a server at predetermined periods; receiving an appropriate tire air pressure based on weather information according to a position of the vehicle from the server, receiving an appropriate tire air pressure and a tire replacement time based on the weather information according to the position of the vehicle and the vehicle's driving information, or receiving an appropriate tire air pressure and a tire replacement time based on the vehicle's fuel efficiency information; and providing the appropriate tire air pressure and the tire replacement time to a driver through a cluster.

The vehicle's driving information may include a vehicle's driving road information, a vehicle's driving distance information, and a vehicle's external temperature information. The fuel efficiency information may include fuel economy degradation factors including fuel efficiency degradation due to the vehicle's fuel efficiency and an amount of air flowing into the engine, fuel efficiency degradation due to quality of fuel, and fuel efficiency degradation due to a tire air pressure.

According to the server and the vehicle according to the embodiments of the present disclosure as described above, it is possible to notify a driver of an appropriate tire air pressure and an appropriate tire replacement time based on a vehicle's position information, a vehicle's driving information, and a vehicle's fuel efficiency information.

### BRIEF DESCRIPTION OF THE DRAWINGS

These drawings are for reference only in describing embodiments of the present disclosure, and therefore, the technical idea of the present disclosure should not be limited to the accompanying drawings.

FIG. 1 illustrates a schematic view of a server and a vehicle according to an embodiment of the present disclosure.

FIG. 2 illustrates a block diagram of a server according to an embodiment of the present disclosure.

FIG. 3 illustrates a block diagram of a vehicle according to an embodiment of the present disclosure.

FIG. 4 illustrates an operational flowchart of a server and a vehicle according to an embodiment of the present disclosure.

### DETAILED DESCRIPTION OF THE EMBODIMENTS

The present disclosure will be described more fully hereinafter with reference to the accompanying drawings, in which embodiments of the disclosure are shown. As those skilled in the art would realize, the described embodiments may be modified in various different ways, all without departing from the spirit or scope of the present disclosure.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

In order to clearly describe the present disclosure, parts that are irrelevant to the description are omitted, and identical or similar constituent elements throughout the specification are denoted by the same reference numerals. In addition, since the size and thickness of each configuration shown in the drawings are arbitrarily shown for convenience of description, the present disclosure is not necessarily limited to configurations illustrated in the drawings, and in order to clearly illustrate several parts and areas, enlarged thicknesses are shown.

In the specification of the present disclosure, the terms “-er”, “-or”, “unit”, “portion”, “part”, and “module” described in the specification mean units for processing at least one function and operation, and can be implemented by hardware components or software components and combinations thereof. In the specification of the present disclosure, a server and a controller are composed of hardware including at least one processor, memory, communication apparatus, etc., and a program executed in combination with hardware is stored in a designated location. The hardware has a configuration and performance to implement a method of the present disclosure. The program includes instructions that implement the method of operation of the present disclosure described with reference to the drawings, and executes the present disclosure in combination with hardware such as a processor and a memory.

Hereinafter, a server and a vehicle according to an embodiment of the present disclosure will be described in detail with reference to the accompanying drawings.

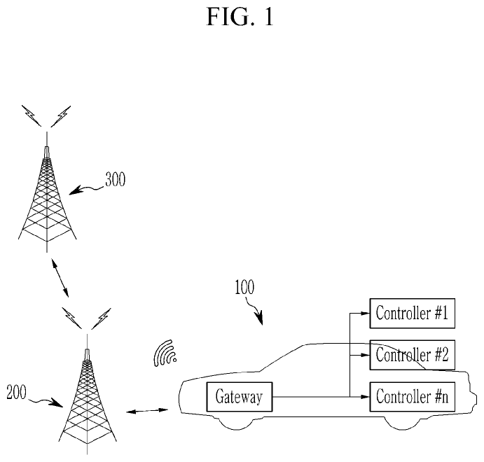

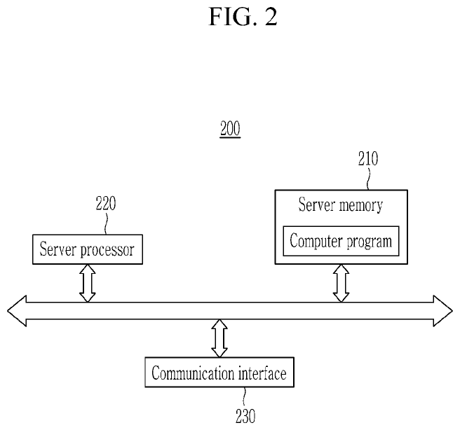

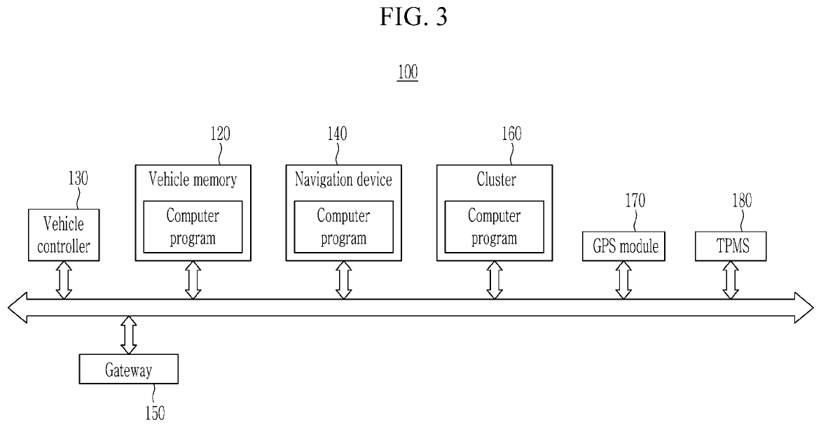

FIG. 1 illustrates a schematic view of a server and a vehicle according to an embodiment of the present disclosure. FIG. 2 illustrates a block diagram of a server according to an embodiment of the present disclosure. FIG. 3 illustrates a block diagram of a vehicle according to an embodiment of the present disclosure. As shown in FIG. 1 to FIG. 3, a server 200 according to an embodiment of the present disclosure is connected to a vehicle 100 via wireless communication to transmit and receive various data to and from each other.

Referring to FIG. 2, the server 200 may include a server memory 210, a server processor 220, and a communication interface 230, and may be connected to them via a bus. The server 200 may be integrated or distributed as necessary. In the embodiment of the present disclosure, the server 200 may be implemented as an over-the-air (OTA) server. The server 200 may include a processor for executing instructions of a computer program, a memory, and the communication interface 230, and may be connected to them via a bus. The computer program includes instructions written to execute operations of the present disclosure. The computer program of the server 200 may be stored in a non-transitory computer readable storage medium.

The processor may be configured to execute an operation of a data processing device, and may be processors of various types capable of processing instructions included in a program, for example, a central processing unit (CPU), a microprocessor unit (MPU), a microcontroller unit (MCU), a graphics processing unit (GPU), and the like. The memory may load the corresponding program so that the instructions written to execute the operation of the present disclosure are processed by the processor. The memory may be, for example, a read only memory (ROM), a random access memory (RAM), or the like. The storage may be configured to store various data, programs, and the like required to execute the operation of the present disclosure. The communication interface 230 may be a wired or wireless communication module. The server 200 may be integrated or distributed as necessary. The name of the server 200 is given for description, and the server 200 is not limited by the name.

Referring to FIG. 3, the vehicle may include a vehicle memory 120, a vehicle controller 130, and a gateway 150. The vehicle memory 120, the vehicle controller 130, and the gateway 150 may be connected via wired communication (for example, a controller area network (CAN)). The vehicle controller 130 may include an engine control unit (ECU) configured to execute an overall operation of an engine.

The vehicle according to the embodiment of the present disclosure may include a global positioning system (GPS) module 170 configured to detect a position of the vehicle, a navigation device configured to provide a driving route of the vehicle, a cluster 160 configured to display various types of vehicle information (for example, a vehicle speed, an engine speed, a fuel amount, a coolant amount, fuel economy, a tire pressure, etc.), and a tire pressure monitoring system (TPMS) 180 configured to measure air pressure of a tire.

The vehicle controller 130 may include at least one processor and a memory. The vehicle controller 130 is a type of computing device, and may be installed with various software including an operating system capable of running a program. The vehicle controller 130 may execute a series of instructions for a control method of the vehicle according to the embodiment of the present disclosure based on data transmitted from the server 200.

The GPS module 170 may be configured to detect a position of the vehicle, and the detected position information of the vehicle is stored in the vehicle memory 120. The navigation device may be configured to receive a departure point (alternatively, the departure point may be a current position of the vehicle detected by the GPS module 170) and a destination from a driver and calculate a driving route of the vehicle, and driving information including road information and a driving distance of the driving route is stored in the vehicle memory 120. The TPMS 180 may be configured to measure the air pressure of the tire, and the measured tire pressure is stored in the vehicle memory 120.

The vehicle controller 130 may be configured to detect the fuel efficiency of the vehicle in real time to store it in the vehicle memory 120, and classify a fuel efficiency degraded factor into a plurality of factors to store them in the vehicle memory 120. The fuel efficiency degraded factor of the vehicle may include a fuel efficiency degraded factor due to an amount of air flowing into the engine, a fuel efficiency degraded factor due to quality of fuel, and a fuel efficiency degraded factor due to a tire. The vehicle controller 130 may be configured to detect the fuel efficiency of the vehicle by continuously sensing an amount of fuel supplied to the engine and an output of the engine. In particular, when the fuel efficiency of the vehicle is less than official fuel efficiency, the vehicle controller 130 may be configured to check and identify the fuel efficiency degraded factor.

The fuel efficiency degraded factors of the vehicle are various, and may include a fuel efficiency degraded factor due to an amount of air flowing into the engine, a fuel efficiency degraded factor due to quality of fuel, and a fuel efficiency degraded factor due to a tire. The fuel efficiency degraded by the amount of air indicates that the fuel efficiency is degraded due to an abnormality in the amount of air flowing into the engine. The vehicle controller 130 may be configured to continuously detect the amount of air flowing into the engine through an air flow sensor (AFS), and determine whether the fuel efficiency of the vehicle is degraded due to an abnormality in the amount of air flowing into the engine. A relationship between the amount of air flowing into the engine and the fuel efficiency may be stored in advance in the vehicle controller 130 in a form of map data.

The fuel efficiency degraded due to the quality of fuel indicates that the fuel efficiency is degraded due to an abnormality in quality of the refueled fuel. The vehicle controller 130 may be configured to detect whether fuel is refueled through a refueling detecting sensor, and determine whether the fuel efficiency of the vehicle is degraded due to an abnormality in the quality of the refueled fuel. In particular, the vehicle controller 130 may be configured to compare the fuel efficiency before refueling and the fuel efficiency after refueling to determine whether fuel efficiency is degraded due to an abnormality in the quality of fuel. A relationship between the fuel quality and the fuel efficiency may be stored in advance in the vehicle controller 130 in a form of map data.

The fuel efficiency degraded due to the tire indicates that the fuel efficiency is degraded due to the air pressure of the tire. The vehicle controller 130 may be configured to detect the air pressure of the tire through the TPMS 180, and determine whether the fuel efficiency of the vehicle is degraded due to the abnormal air pressure of the tire. A relationship between the air pressure of the tire and the fuel efficiency may be stored in advance in the vehicle controller 130 in a form of map data. The vehicle controller 130 may be configured to transmit the position information of the vehicle, the air pressure of the tire, the driving information of the vehicle, and the fuel efficiency information of the vehicle to the server at predetermined periods.

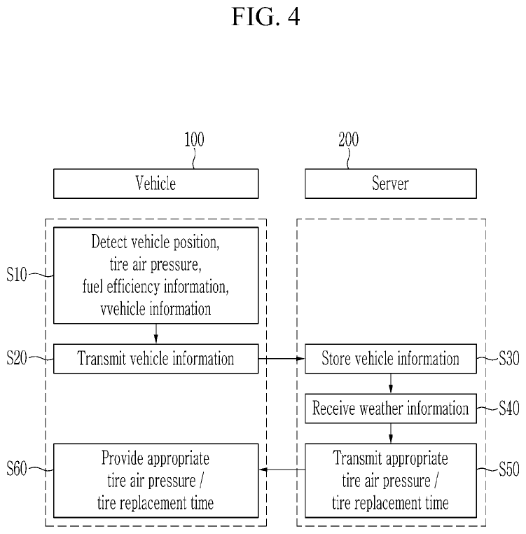

Hereinafter, operations of the server and the vehicle of the present disclosure will be described in detail with reference to the accompanying drawings. FIG. 4 illustrates an operational flowchart of the server and the vehicle according to the embodiment of the present disclosure. As shown in FIG. 4, the GPS module 170 mounted on the vehicle detects the position of the vehicle, and the detected position information of the vehicle is stored in the vehicle memory 120 (S10). The TPMS 180 may be configured to continuously detect the tire air pressure, and the detected tire air pressure is stored in the vehicle memory 120 (S10).

The vehicle controller 130 may be configured to continuously calculate the fuel efficiency of the vehicle while the vehicle is driving, and continuously detect factors that have degraded fuel efficiency. As described above, the fuel efficiency degraded factor may include a fuel efficiency degraded factor due to an amount of air flowing into the engine, a fuel efficiency degraded factor due to quality of fuel, and a fuel efficiency degraded factor due to a tire. Fuel efficiency information including the calculated fuel efficiency of the vehicle, the official fuel efficiency of the vehicle, and the fuel efficiency degraded factor is stored in vehicle memory 120 (S10). In addition, the navigation device 140 may be configured to calculate the driving information including the driving route, driving road, and driving distance of the vehicle for a predetermined period, and the calculated driving information is stored in the vehicle memory 120 (S10). The driving road information of the vehicle may include road information of the route traveled by the vehicle (for example, paved roads, unpaved roads, national roads, highways, etc.).

The vehicle controller 130 may be configured to transmit vehicle information including the position information of the vehicle, the tire air pressure, the fuel efficiency information of the vehicle, and the driving information of the vehicle to the server 200 at predetermined periods (S20). The vehicle information transmitted from the vehicle 100 is stored in the server memory 210 (S30). The server processor 220 may be configured to access a weather server 300 to receive weather information according to the position of the vehicle, and the received weather information is stored in the server memory 210 (S40).

The server processor 220 may be configured to transmit the appropriate air pressure of the tire based on the weather information according to the position of the vehicle received from the weather server 300 to the vehicle 100 (S50). For example, when the vehicle travels in a hot area (e.g., excessive temperature), the server processor 220 may allow the appropriate air pressure to be greater than a standard air pressure. On the other hand, when the vehicle travels in a cold area (e.g., during winter), the server processor 220 may allow the appropriate air pressure to be less than a standard air pressure. The weather in which the vehicle is positioned and the appropriate air pressure of the tire may be stored in advance in the server memory 210 in a form of map data.

The server processor 220 may be configured to transmit the appropriate tire pressure and the tire replacement time to the vehicle 100 based on the weather information according to the position of the vehicle and the driving information of the vehicle (S50). The server processor 220 may be configured to transmit the appropriate tire air pressure and the tire replacement time to the vehicle 100 based on the driving road information and the driving distance transmitted from the vehicle 100, and the external temperature information of the vehicle transmitted from the weather server 300. In particular, when the vehicle 100 drives more or further than a set driving distance on a set driving road, the server 200 may be configured to transmit a tire replacement request to the vehicle 100.

For example, when the vehicle travels in a hot area, the server processor 220 may allow the appropriate air pressure to be greater than a standard air pressure. On the other hand, when the vehicle travels in a cold area, the server processor 220 may allow the appropriate air pressure to be less than a standard air pressure. In addition, when the vehicle travel distance on an unpaved road is relatively long (e.g., greater than a predetermined distance), the server processor 220 may be configured to determine the tire replacement time to be less than a standard replacement time. On the other hand, when the distance that the vehicle travels on a general road (for example, a national road or a highway) is relatively long, the server processor 220 may be configured to determine the tie replacement time as the standard replacement time. The standard air pressure may be 240 kPa, and the standard replacement time may be between 3 and 5 years.

The server processor 220 may be configured to transmit the appropriate tire air pressure based on the fuel efficiency information of the vehicle to the vehicle 100 (S50). In particular, the server processor 220 may be configured to transmit the appropriate tire pressure to the vehicle based on the previously stored official fuel efficiency of the vehicle 100 and the fuel efficiency information transmitted from the vehicle 100. The server processor 220 may be configured to continuously monitor the fuel efficiency of the vehicle through the fuel efficiency information transmitted from the vehicle 100.

When the fuel efficiency of the vehicle is less than the official fuel efficiency, the server processor 220 may be configured to monitor the fuel efficiency degraded factor and detect whether the fuel efficiency is degraded due to the tire air pressure or the tire replacement time. When the fuel efficiency of the vehicle is less than the official fuel efficiency due to the fuel efficiency degraded factor due to the tire air pressure or the tire replacement time, the server processor 220 may be configured to transmit the appropriate tire air pressure and/or the tire replacement time to the vehicle 100.

For example, the cases in which the fuel efficiency of the vehicle is less than the official fuel efficiency from the fuel efficiency information, the fuel efficiency of the vehicle is not degraded due to an abnormality of the amount of air supplied to the engine, the fuel efficiency of the vehicle is not degraded due to the quality of the fuel, and the fuel efficiency of the vehicle is degraded due to the tire air pressure or the tire replacement time, may occur. In particular, the server 200 may be configured to transmit the appropriate air pressure of the tire or the replacement time of the tire to the vehicle 100.

The appropriate tire air pressure based on the weather information according to the position of the vehicle transmitted from the server 200, the appropriate tire pressure and the tire replacement time based on the weather information according to the position of the vehicle and the driving information of the vehicle, and/or the tire air pressure and the tire replacement time based on the fuel efficiency information of the vehicle are stored in the vehicle memory 120. The vehicle controller 130 provides the appropriate air pressure of the tire transmitted from the server 200 and the replacement time of the tire to the driver through the cluster 160 (S60).

According to the server and the vehicle according to the embodiments of the present disclosure as described above, it is possible to notify a driver of an appropriate tire air pressure and an appropriate tire replacement time based on a vehicle's position information, a vehicle's driving information, and a vehicle's fuel efficiency information. Meanwhile, the server 200 according to the embodiment of the present disclosure may be realized as an over-the-air (OTA) server 200. The OTA server 200 transmits/receives various data to and from the vehicle controller 130 via wireless communication with the vehicle controller 130, thereby more smoothly providing necessary information to the vehicle controller 130.

The above-described embodiments may be realized through a program for realizing functions corresponding to the configuration of the embodiments or a recording medium for recording the program in addition to through the above-described device and/or method, which is easily realized by a person skilled in the art.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

100: vehicle
120: vehicle memory
130: vehicle controller
140: navigation device
150: gateway
160: cluster
170: GPS module
180: tire pressure monitoring system
200: server
210: server memory
220: server processor
230: communication interface

What is claimed is:

1. A server, comprising:
a server memory; and
a server processor configured to execute instructions loaded into the server memory,
wherein the server processor is configured to execute a series of instructions, including:
storing position information of a vehicle, driving information of the vehicle, and fuel efficiency information of the vehicle transmitted at predetermined periods from the vehicle in the server memory;
receiving weather information according to a position of the vehicle from a weather server to store the weather information in the server memory; and
transmitting an appropriate tire air pressure based on the weather information based on a vehicle position to the vehicle, transmitting an appropriate tire air pressure and a tire replacement time based on the weather information based on the vehicle position and the driving information to the vehicle, or transmitting the appropriate tire air pressure and the tire replacement time based on the fuel efficiency information to the vehicle.

2. The server of claim 1, wherein:
the driving information includes a driving route, driving road information, and driving distance information of the vehicle; and
the server processor is configured to transmit the appropriate tire air pressure and the tire replacement time to the vehicle based on the driving road information and the driving distance information transmitted from the vehicle and external temperature information of the vehicle transmitted from the weather server.

3. The server of claim 2, wherein the server processor is configured to transmit tire replacement information to the vehicle when the vehicle travels further than a set driving distance on a set driving road.

4. The server of claim 1, wherein the server processor is configured to transmit the appropriate tire air pressure to the vehicle based on a previously stored official fuel efficiency of the vehicle and the fuel efficiency information.

5. The server of claim 4, wherein the fuel efficiency information includes fuel economy degradation factors including fuel efficiency degradation due to the fuel efficiency of the vehicle and an amount of air flowing into the engine, fuel efficiency degradation due to quality of fuel, and fuel efficiency degradation due to a tire air pressure.

6. The server of claim 5, wherein the server processor is configured to continuously monitor the fuel efficiency information transmitted from the vehicle, and transmit the appropriate tire air pressure to the vehicle when the fuel efficiency of the vehicle is less than an official fuel efficiency due to the fuel efficiency degradation due to the tire air pressure.

7. A vehicle, comprising:
a vehicle memory; and
a vehicle controller configured to execute instructions loaded into the vehicle memory,
wherein the vehicle controller is configured to execute a series of instructions, including:
transmitting position information of the vehicle, driving information of the vehicle, and fuel efficiency information of the vehicle to a server at predetermined periods of time;
receiving an appropriate tire air pressure based on weather information according to a position of the vehicle from the server, receiving an appropriate tire air pressure and a tire replacement time based on the weather information according to the position of the vehicle and the driving information, or receiving the appropriate tire air pressure and the tire replacement time based on the fuel efficiency information; and
providing the appropriate tire air pressure and the tire replacement time to a driver through a cluster.

8. The vehicle of claim 7, wherein the driving information includes driving road information, driving distance information of the vehicle, and external temperature information.

9. The vehicle of claim 7, wherein the fuel efficiency information includes fuel economy degradation factors including fuel efficiency degradation due to the fuel efficiency of the vehicle and an amount of air flowing into the engine, fuel efficiency degradation due to quality of fuel, and fuel efficiency degradation due to a tire air pressure.
